(19) United States
(12) Patent Application Publication
(10) Pub. No.: US 2011/0106932 A1
(43) Pub. Date: May 5, 2011

(54) Network Management System

(75) Inventors: Liam Fallon, Roscommon (IE); Ronan Barrett, Dublin (IE); Paddy Farrell, Offaly (IE)

(73) Assignee: TELEFONAKTIEBOLAGET LM ERICSSON (PUBL), Stockholm (SE)

(21) Appl. No.: 12/988,575

(22) PCT Filed: Apr. 21, 2008
(86) PCT No.: PCT/EP2008/054793

§ 371 Date: Jan. 6, 2011

(51) Int. Cl. G06F 15/173

(52) U.S. Cl. 709/223

(57) ABSTRACT

A telecommunications network for providing broadband access comprising a network management node arranged to manage a plurality of network nodes forming part of the network, the network management node adapted to send, receive and process management protocol messages, the network nodes including a head node that is connected to each of a plurality of peer nodes, the head node and the peer nodes each including a management module, the management modules being configured such that the peer nodes are grouped into a hierarchical group and wherein the management module of the head node is adapted to forward a management protocol message to a first peer node of the peer nodes and wherein the management modules of the peer nodes are adapted to forward the management protocol message to each peer node within the group.

### TECHNICAL FIELD

This invention relates to a network management system for managing a network. In particular, it relates to a network management system for a broadband access network. It also relates to a method of operation of the network management system.

### BACKGROUND

Broadband access networks are currently being asked to deliver vastly different services to those previously. Originally, the primary services were voice and low bandwidth “best effort” data services such as web browsing and email. Now, the services being offered are much more bandwidth hungry and demand a high level of Quality of Service (QoS). Applications such as high definition Internet Protocol Television (IPTV) require the broadband access networks to deliver a consistent high capacity high quality data service. It is therefore important for broadband access networks to manage the broadband access infrastructure so that they can deliver such services in the most efficient manner possible taking account of the network services that are running on that infrastructure at any one time.

Further, as the rate of broadband penetration to users continues to increase, the broadband access networks are becoming increasingly complex. Efficient management of these networks is essential to ensure correct and effective utilisation of existing broadband infrastructure.

Known broadband access networks typically use a centralised management agent to implement network resource management. Such network resource management is used in the field of broadband to keep track of what lines are connected to what switches, the bandwidth available and the bandwidth used, and some basic level features such as QoS management. Commonly broadband access management solutions are implemented using a centralised top down architecture with dedicated management infrastructure, using the layered manager-agent paradigm proposed by ITU's Telecommunications Management Network (TMN).

### SUMMARY

According to a first aspect of the invention, we provide a telecommunications network for providing broadband access comprising a network management node arranged to manage a plurality of network nodes forming part of the network, the network management node adapted to send, receive and process management protocol messages, the network nodes including a head node that is connected to each of a plurality of peer nodes, the head node and the peer nodes each including a management module, the management modules being configured such that the peer nodes are grouped into a hierarchical group and wherein the management module of the head node is adapted to forward a management protocol message to a first peer node of the peer nodes and wherein the management modules of the peer nodes are adapted to forward the management protocol message to each peer node within the group.

This is advantageous as management protocol message traffic on the network is low as the messages are distributed efficiently. The domain manager node, which issues the management messages, is able to effectively manage the network without overloading it with network management protocol messages. The network is optimised as there is only one call made to a network node from the domain manager node and from the network node, only one call is required to any further network nodes. This is achieved by grouping the network nodes into groups which are passed management protocol messages from a head node to a first peer node. The group of peer nodes are then responsible for distributing the message throughout the group. Scalability in the broadband access network is achieved as the level of management related traffic does not increase directly with the number of new end-user lines added to the access network, for example.

At least one of the peer nodes may form a head node for a further hierarchical group. The management modules thus arrange the network into layers of hierarchical groups. This grouping distributes the burden of forwarding management protocol messages across the whole network which is efficient. Thus, although the head node may have direct connections to each one of the group of peer nodes, it is only required to forward the management protocol message once to the first peer node.

The peer nodes may be arranged to forward the management protocol messages to no more than one other peer node such that the messages are forwarded to each peer node within the group. Management protocol message distribution within the group is therefore spread over each node in the group as each peer node forwards the message to one other peer node until it reaches the final peer node such that all members of the group have received the message.

The hierarchical group may comprise a first peer node and a final peer node, the peer nodes including peer-to-peer network links for forwarding management protocol messages, the links arranged such that the first peer node is connected to the final peer node via each of the other peer nodes of the hierarchical group. This arrangement uses a minimum amount of network infrastructure to provide efficient distribution of network management protocol messages within the hierarchical group.

According to a second aspect of the invention we provide a method of forwarding network management protocol messages over a telecommunications network, the network comprising a network management node arranged to manage a plurality of network nodes forming part of the network, the network management node adapted to send, receive and process management protocol messages, the network nodes including a head node that is connected to each of a plurality of peer nodes, the head node and the peer nodes including a management module, the management module being configured such that the peer nodes are grouped into a hierarchical group, the management module performing the following steps;
a) receive a management protocol message;
b) determine whether or not the management protocol message should be forwarded to a peer node in the hierarchical group and, if so, forward the management protocol message to that peer node;
c) determine whether or not the management protocol message should be forwarded to a peer node in a further hierarchical group and, if so, forward the management protocol message to that peer node.

The method provides an efficient scheme for forwarding network management protocol messages. Each node has responsibility for forwarding the messages within its hierarchical group and to any further groups to which it is designated as a head node. The determination whether the node should forward the message within a group or to a further group may be predetermined with the management modules pre-programmed to forward the messages where necessary. Thus, if the node determines that the message should not be forwarded it takes no further action.

One of the peer nodes of the hierarchical group may comprise a first peer node, the management modules of the network nodes performing the following steps; generate a management protocol message addressed for the network management node; and forward the management protocol message addressed to the network management node via the first peer node. Thus, the method directs management protocol messages destined for the network management node via the nodes of the hierarchical group to the first peer node of its group and any further groups between it and the network management node.

According to a third aspect of the invention we provide a network node for forming part of a telecommunications network for providing broadband access, the network comprising a network management node arranged to manage the network and adapted to send, receive and process management protocol messages, the network node including a management module configured such that the network node is adapted to form part of a hierarchical group of peer nodes, the management module further configured to a receive management protocol message and to determine whether or not the management protocol message should be forwarded to a peer node in the hierarchical group and, if so, forward the management protocol message to that peer node and determine whether or not the management protocol message should be forwarded to a peer node in a further hierarchical group and, if so, forward the management protocol message to that peer node.

The network node is advantageous as it is able to forward management protocol messages in an efficient manner. The load on the node due to the forwarding of the management messages is minimal compared to the resultant efficiency and scalability of the network it forms part.

The network node may be adapted to include a peer-to-peer link to a further peer node in the hierarchical group. The peer-to-peer links enable efficient forwarding of management messages between peer nodes.

The management module of the network node may be adapted to only control the forwarding of management protocol messages. The provision of a dedicated management module allows the management messages to be efficiently distributed throughout the network taking up minimal bandwidth, while other types of traffic, such as data traffic, it routed by the most direct route.

### BRIEF DESCRIPTION OF THE DRAWINGS

FIG. 1 shows an example of a broadband access network;

FIG. 2 shows a management protocol message propagation diagram for the network of FIG. 1 operating by a known method;

FIG. 3 shows an example of a broadband access network including certain peer to peer links;

FIG. 4 shows the distribution of management protocol messages over the network of FIG. 3 in accordance with an embodiment of the present invention;

FIG. 5 shows the network of FIG. 1 modified to include peer to peer links;

FIG. 6 shows a management protocol message propagation diagram for the network of FIG. 5 operating in accordance with an embodiment of the present invention; and

FIG. 7 is a flow chart showing an example of the method of the invention.

### DETAILED DESCRIPTION

The embodiment of the present invention described herein has particular relevance to the management of broadband access networks. A broadband access network provides broadband internet access and other services to a plurality of end-users. Several end-users are typically connected to a Digital Subscriber Line Access Multiplexer (DSLAM) which multiplexes the Digital Subscriber Lines of each end-user. The DSLAMs are typically connected to several aggregation nodes which comprise switches that aggregate traffic received from DSLAMs. Network resource management is used in the field of broadband access networks to keep track of what lines are connected to what switches, the utilised and unutilised bandwidth and some basic level features such as QoS management. Existing broadband access management solutions have been implemented using a centralised top down architecture with dedicated management infrastructure, using the layered manager-agent paradigm as proposed by ITU's Telecommunications Management Network (TMN).

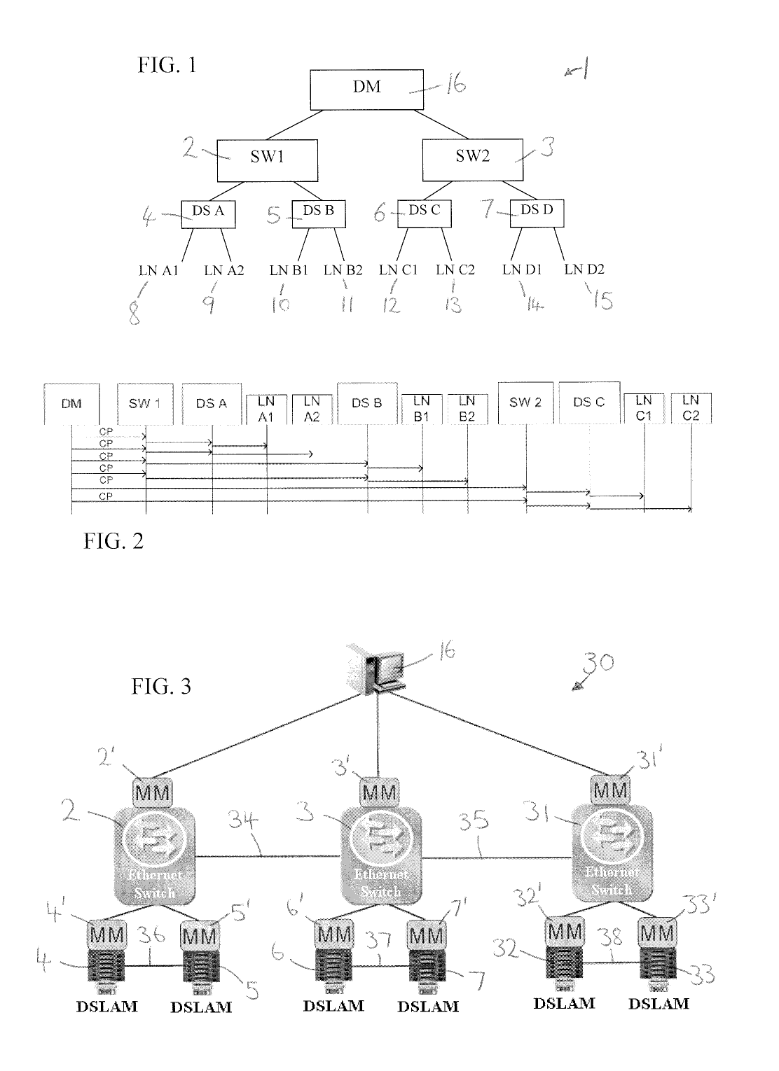

FIG. 1 shows a portion of a broadband access network 1 operating under a known management scheme. This exemplary broadband access network 1 comprises two switch nodes; a first switch node 2 and a second switch node 3. The first switch node 2 is connected to two DSLAMs 4, 5 designated first and second respectively. The second switch node 3 is connected to a third DSLAM 6 and fourth DSLAM 7. The first DSLAM 4 multiplexes a first Digital Subsciber Line (DSL) 8 and a second DSL 9. The second DSLAM 5 multiplexes DSL 10 and DSL 11, the third DSLAM 6 multiplexes DSL 12 and DSL 13 and the fourth DSLAM 7 multiplexes DSL 14 and DSL 15.

The network 1 also includes a network management node in the form of domain manager node 16, that is adapted to manage the switch nodes 2 and 3 and DSLAMs 4, 5, 6, 7. The domain manager node 16 is adapted to send, receive and process network management protocol messages.

If the domain manager node 16 wishes to apply changes to a profile in the network 1, it sends the relevant management protocol messages to each individual line 8, 9, 10, 11, 12, 13, 14 and 15 in the network, as shown in FIG. 2. FIG. 2 is a management protocol message propagation diagram for the network of FIG. 1 and shows the messages sent by the domain manager node 16 to control the line usage. In the diagram, the letters “SW” are used to designate a switch, “DS” to designate a DSLAM and “LN” to designate a line. Thus, a management protocol message is sent from the domain manager 16 to line 8 (LN A1) via switch node 2 and DSLAM 4. Thus, the domain manager node 16 needs to send eight management protocol messages to perform a “configure profile” operation for the eight lines. Only six of these messages are shown in FIG. 2 for simplicity.

As the network 1 grows in size so too does the number of management protocol messages required to manage it. The level of management related activity on a network will be greater the higher up the network levels, i.e. towards domain manager node 16. Thus, with the traditional centralised approach to network management it is difficult to perform resource management in real or near real time in response to rapid changes in line usage and significant network bandwidth is used for management protocol messages. In particular, the latency of the resource allocation updates increase significantly when a large number of actions are implemented by the domain manager node 16 or when the size of the network 1 increases. In addition to the bandwidth used to monitor resource usage, when changes to line configurations are applied they are performed individually to each DSLAM via the switch. Alarm monitoring is also performed for each individual node. Domain manager nodes use the same connection that is used for data transmission and therefore the management protocol messages occupy bandwidth for polling and configuration that could be better used for user data transmission.

FIG. 3 shows a decentralised view of a broadband access network 30 which includes peer-to-peer connections. The structure of the network 30 is similar to that of FIG. 1 except that a third switch node 31 is shown that is connected to a fifth DSLAM 32 and a sixth DSLAM 33. Further, additional peer-to-peer links are provided between various network nodes. A link 34 is provided between first switch node 2 and second switch node 3. A link 35 is provided between second switch node 3 and third switch node 31. A link 36 is provided between first DSLAM 5 and second DSLAM 6. A link 37 is provided between first DSLAM 8 and second DSLAM 9. A link 38 is provided between fifth DSLAM 32 and sixth DSLAM 33.

In accordance with an embodiment of the invention, management modules are included within the network nodes. Thus, the first switch 2 includes a management module 2′; the second switch 3 a management module 3′; and the third switch 31 a management module 31′. Similarly, the DSLAMs 4, 5, 6, 7, 32, 33 include management modules 4′, 5′, 6′, 7′, 32′ and 33′ respectively.

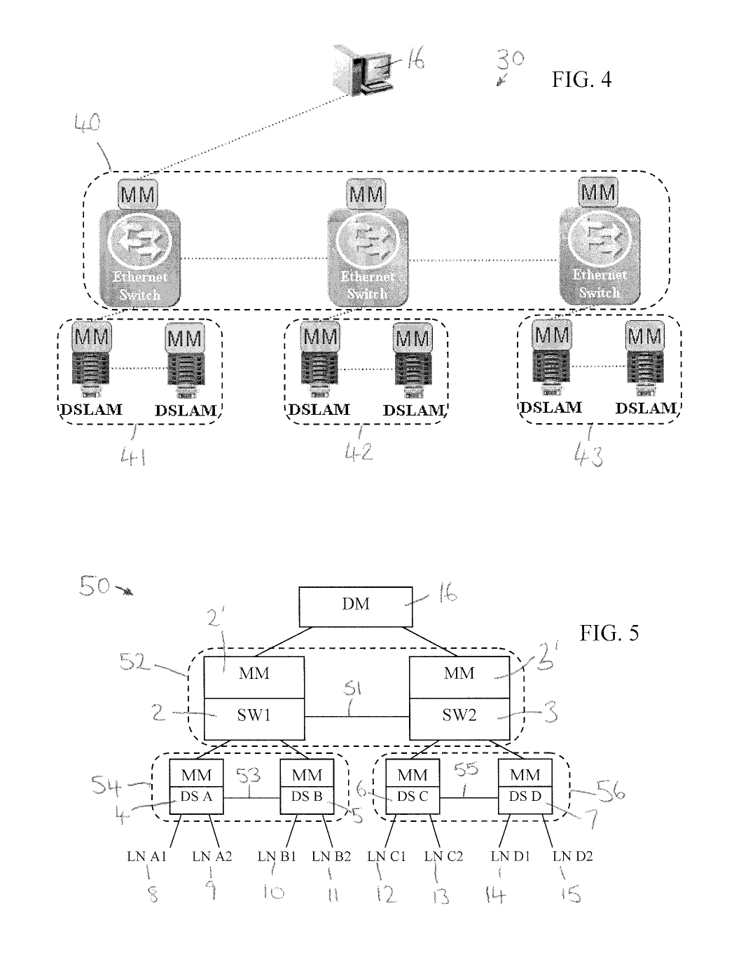

The route of a management protocol message in accordance with an embodiment of the invention over the broadband access network 30 is shown in FIG. 4. The management protocol message is generated by the domain manager node 16 and sent only to the first switch node 2. The management modules 2′, 3′ and 31′ of the first switch node 2, second switch node 3 and third switch node 31 are configured such that the first, second and third switch nodes 2, 3, 31 form a hierarchical group 40 of peer nodes. The domain manager node 16 acts as a head node for the switch nodes 2, 3, 31. Thus, the management module 2′ is configured to forward the management protocol message to the management module 3′ of the second switch node 3. Likewise, the management module 3′ is configured to forward the management protocol message to the management module 31′ of the third switch node 31. The management protocol messages are thus forwarded to each peer node within the group 40.

In this regard, each hierarchical group includes a first peer node and a final peer node and the management protocol messages are forwarded between the first peer node and the final peer node via all the other peer nodes in the group. The final peer node is programmed not to forward the message to any other peer nodes in the group. Thus, the first switch node 2 is the first peer node and the third switch node 31 is the final peer node. The network 30 includes sufficient peer-to-peer links such that a management protocol message can be forwarded from the first peer node to the final peer node. Preferably, the first peer node and the final peer node include a single peer-to-peer link each and each intermediate peer node includes two peer-to-peer links. Network infrastructure is therefore at a minimum while providing a network that can efficiently forward management protocol messages.

The management modules 4′, 5′ of the first DSLAM 4 and the second DSLAM 5 are configured such that the first DSLAM 4 and second DSLAM 5 form a further hierarchical group 41. The management modules 6′, 7′ of the third DSLAM 6 and the fourth DSLAM 7 are configured such that the third DSLAM 6 and fourth DSLAM 7 form a further hierarchical group 42. Similarly, the management modules 32′, 33′ of the fifth DSLAM 32 and the sixth DSLAM 33 are configured such that the fifth DSLAM 32 and sixth DSLAM 33 form a still further hierarchical group 43.

Therefore, the first switch node 2 acts as a head node for the group 41 of peer DSLAM nodes 4, 5. The second switch node 3 acts as a head node for the group 42 of peer DSLAM nodes 6, 7. The third switch node 31 acts as a head node for the group 43 of peer DSLAM nodes 32, 33. The first DSLAM 4 is the first peer node in its group 41 and the second DSLAM 6 is the final peer node. The third DSLAM 6 is the first peer node in its group 42 and the fourth DSLAM 7 is the final peer node. The fifth DSLAM 32 is the first peer node in its group 43 and the sixth DSLAM 33 is the final peer node

The management module 2′ therefore forwards the management protocol message to only the first DSLAM 4 (the first peer node of group 41), which, in turn, forwards it to the second DSLAM 5 (the final peer node of group 41). The management module 3′ forwards the management protocol message to only the third DSLAM 6 (the first peer node of group 42), which, in turn, forwards it to the fourth DSLAM 9 (the final peer node of group 42). The management module 31′ therefore forwards the management protocol message to only the fifth DSLAM 32 (the first peer node of group 43), which, in turn, forwards it to the sixth DSLAM 33 (the final peer node of group 43). The management modules of the third switch node 31, the second DSLAM 5, the fourth DSLAM 7 and the sixth DSLAM 33, are programmed not to forward the management protocol message to any other peer node in their respective groups as they are the final nodes in their respective hierarchical groups 40, 41, 42, 43.

Any management protocol messages sent by the network nodes will follow the same path to the domain manager node 16 as a message sent from the domain manager node 16

This approach of grouping the nodes into hierarchical groups, which forward the management messages within them and to a first peer node in any further group leads to an efficient distribution of management messages. The use of management modules implementing such a distribution scheme is well suited to broadband access network, which have static nodes and static lines and limited resources. Further, the layered structure of a broadband access network lends itself to the efficient grouping of nodes that spread the burden of distributing network management messages. This approach still utilises a single central Domain Manager, although it achieves significantly improved network efficiency by pushing down much of the message passing processing to lower levels in the network to improve scalability.

FIG. 5 shows a broadband access network 50 similar to the network of FIG. 1 but including management modules for each network node and certain peer to peer links. A peer to peer link 51 is arranged between first switch node 2 and second switch node 3. The first switch node 2 acts as a first peer node and the second switch node 3 acts as a final peer node in a first hierarchical group 52. A peer to peer link 53 is arranged between first DSLAM 4 and second DSLAM 5. The first DSLAM 4 acts as a first peer node and second DSLAM 5 acts as a final peer node in a second hierarchical group 54. A peer to peer link 55 is arranged between third DSLAM 6 and fourth DSLAM 7. The third DSLAM 6 acts as a first peer node and fourth DSLAM 7 acts as a final peer node in a third hierarchical group 56.

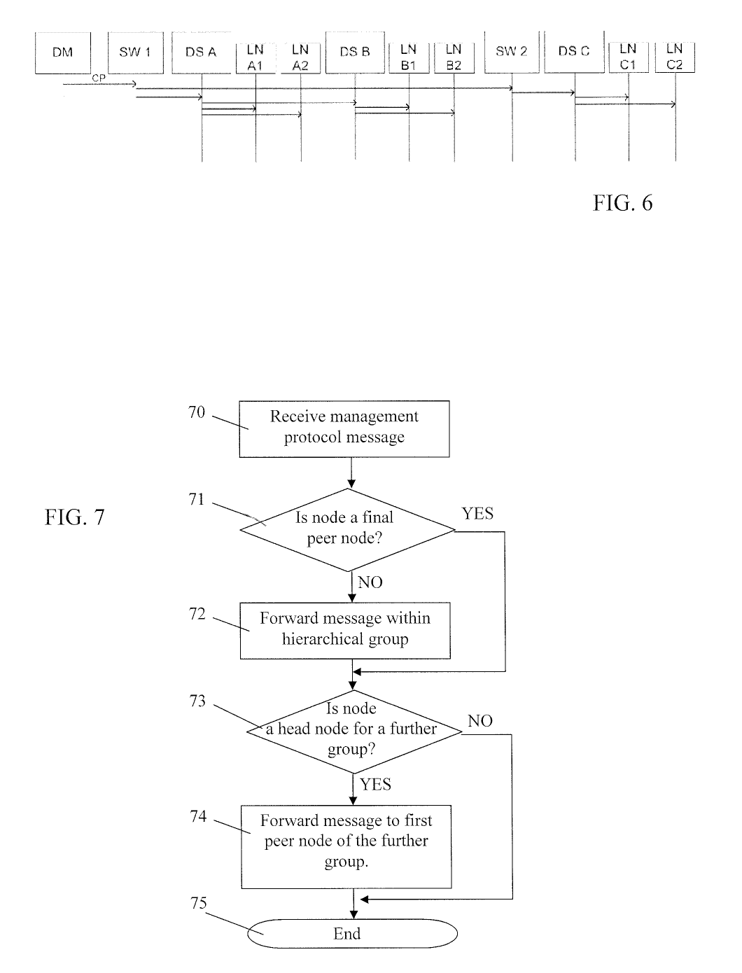

As a comparison to FIG. 2, FIG. 6 shows how management protocol messages propagate over the network 50, when operating in accordance with an embodiment of the invention. The number of messages sent by the domain manager node 16 is reduced from eight to one. Further, the first and second switch node do not have to processes as many messages as the responsibly for distributing the management protocol messages to each DSL line 8, 9, 10, 11, 12, 13, 14, 15 is passed to the DSLAMs 4, 5, 6, 7. This provides an efficient use of network resources without using a complex, fully peer-to-peer management network overlay. Management related bandwidth usage between any DSL line and ultimately the core network is reduced dramatically higher up the network. This is because in known centralised architectures there is typically ‘n’ management related calls made between a switch and the Domain Manager, where ‘n’ is the number of DSL lines provided by the DSLAMs connected to that switch. The number of calls in the present embodiment is reduced to just one call.

FIG. 7 shows a flow chart for an embodiment of the management protocol message distribution method. Step 70 involves a network node receiving a network management protocol message. At step 71 it is determined whether or not the node is a final peer node. The status of a node as a final peer node is predetermined and the node's associated management module will be programmed with where to forward management protocol messages. If the node is a final peer node in a group then no action is taken to forward the message within the group the node forms part. If the node is not a final peer node, then at step 72 the management module of the node forwards the message to the predetermined next node in the group. At step 73 it is determined whether or not the present node is a head node for a further hierarchical group. As at step 71, the management module of the present node is pre-programmed with the status of the node and will thus forward the management protocol message as appropriate. If the present node is a head node the message is forwarded to the first peer node of the further hierarchical group at step 74. If the node does not form a head node, the method proceeds to step 75, where the method ends. The method will, of course, restart at step 70 when a further management protocol message is received.

It will be appreciated that the management modules of the nodes may not be pre-programmed with where they need to forward management protocol messages and may have functionality to “discover” where they need to send the messages. This may involve the interrogation of neighbouring nodes either during an initial start-up routine or periodically when in use.

1. A telecommunications network for providing broadband access comprising a network management node arranged to manage a plurality of network nodes forming part of the network, the network management node adapted to send, receive and process management protocol messages, the network nodes including a head node that is connected to each of a plurality of peer nodes, the head node and the peer nodes each including a management module, the management modules being configured such that the peer nodes are grouped into a hierarchical group and wherein the management module of the head node is adapted to forward a management protocol message to a first peer node of the peer nodes and wherein the management modules of the peer nodes are adapted to forward the management protocol message to each peer node within the group.

2. A telecommunications network according to claim 1, in which at least one of the peer nodes forms a head node for a further hierarchical group.

3. A telecommunications network according to claim 1, in which the peer nodes are arranged to forward the management protocol messages to no more than one other peer node such that the messages are forwarded to each peer node within the group.

4. A telecommunications network according to claim 1, in which the hierarchical group comprises a first peer node and a final peer node, the peer nodes including peer-to-peer network links for forwarding management protocol messages, the links arranged such that the first peer node is connected to the final peer node via each of the other peer nodes of the hierarchical group.

5. A method of forwarding network management protocol messages over a telecommunications network, the network comprising a network management node arranged to manage a plurality of network nodes forming part of the network, the network management node adapted to send, receive and process management protocol messages, the network nodes including a head node that is connected to each of a plurality of peer nodes, the head node and the peer nodes including a management module, the management module being configured such that the peer nodes are grouped into a hierarchical group, the management module performing the following steps:
a) receiving a management protocol message;
b) determining whether or not the management protocol message should be forwarded to a peer node in the hierarchical group and, if so, forwarding the management protocol message to that peer node;
c) determining whether or not the management protocol message should be forwarded to a peer node in a further hierarchical group and, if so, forwarding the management protocol message to that peer node.

6. A method according to claim 5, in which one of the peer nodes of the hierarchical group comprises a first peer node, the management modules of the network nodes performing the following steps:
(a) generating a management protocol message addressed for the network management node;
(b) forwarding the management protocol message addressed to the network management node via the first peer node.

7. A network node for forming part of a telecommunications network for providing broadband access, the network comprising a network management node arranged to manage the network and adapted to send, receive and process management protocol messages, the network node including a management module configured such that the network node is adapted to form part of a hierarchical group of peer nodes, the management module further configured to receive a management protocol message and to determine whether or not the management protocol message should be forwarded to a peer node in the hierarchical group and, if so, forward the management protocol message to that peer node and determine whether or not the management protocol message should be forwarded to a peer node in a further hierarchical group and, if so, forward the management protocol message to that peer node.

8. A network node according to claim 7, in which the network node is adapted to include a peer-to-peer link to a further peer node in the hierarchical group.

9. A network node according to claim 7, in which the management module of the network node is adapted to only control the forwarding of management protocol messages.
